(19) United States
(12) Patent Application Publication
(10) Pub. No.: US 2024/0347221 A1
(43) Pub. Date: Oct. 17, 2024

(54) IMPROVED RADIATION SHIELDING

(71) Applicant: THE UNIVERSITY OF ADELAIDE, South Australia (AU)

(72) Inventors: Dusan Losic, South Australia (AU); Le Yu, South Australia (AU); Diana Tran, South Australia (AU); Alex Santos, South Australia (AU); Tung Tran, South Australia (AU); Md Nine Julker, South Australia (AU)

(73) Assignee: THE UNIVERSITY OF ADELAIDE, South Australia (AU)

(21) Appl. No.: 18/685,087

(22) PCT Filed: Aug. 19, 2022
(86) PCT No.: PCT/AU2022/050929

§ 371 Date: Feb. 20, 2024

(30) Foreign Application Priority Data
Aug. 20, 2021 (AU) 2021902612

(51) Int. Cl. G21F 1/12; B82Y 30/00; G21F 1/06; G21F 1/10

(52) U.S. Cl. CPC G21F 1/12; B82Y 30/00; G21F 1/06; G21F 1/10

(57) ABSTRACT

Layered nanolaminates (LNL) containing assembled sheets of 2-dimensional (2D) materials with high atomic numbers (Z). namely of transition metal dichalcogenides. Group III and IV chalcogenides and chalcogenides. which have high radiation shielding properties due to the density of their nucleus.

### FIELD OF THE INVENTION

This present invention relates to layered nanolaminates (LNL) containing assembled sheets of 2-dimensional (2D) materials with high atomic numbers (Z) and densities able to provide radiation shielding. In particular, the invention to LNL are composed of 2D materials made of Transition Metal Dichalcogenides, Group III and IV Chalcogenides and Chalcogenides employed as shielding elements with high Z numbers which provide high shielding properties due to the density of their nucleus.

### BACKGROUND

Ionizing radiation that is emitted from radioactive materials and natural sources can be classified as either α, β, γ, x, or neutrons in the forms of the radiated waves or particles. They are hazardous and could cause lethal or serious health problems to people and the environment if not protected.

There are greater than 100 million people worldwide who are exposed directly and daily to man-made ionizing radiation, including patients and workers in hospitals, nuclear plants, agriculture, space and defence industries. Around double, this large population have also been accidentally exposed to radiation as results of two catastrophic nuclear disasters (Chernobyl and Fukushima). Considering worst-case scenarios involving potential local or global nuclear conflicts using nuclear weapons, billions of people or the entire Earth population could be affected by exposure to post-nuclear radiation.

To have efficient, low-cost and affordable radiation protection in all these scenarios,, is a critical and significant global problem. Historically, the radiation shielding materials able to block and absorb most of these ionizing radiations have been manufactured from a metallic lead (Pb) which has many limitations, such as being too heavy, uncomfortable to wear, highly toxic, non-disposable, environmentally unsustainable and not able to protect from the neutron radiation.

In recent years, to address some of these limitations, several different attempts have been explored, however, there is still a significant need for the development of a new generation of lead-free ionizing-radiation protection materials and technologies that are lightweight, non-toxic, cost-effective, sustainable and comply with international and national radiation safety standards.

### OBJECT OF THE INVENTION

It is an object of the present invention to overcome, or at least substantially ameliorate, the disadvantages and shortcomings of the prior art.

Other objects and advantages of the present invention will become apparent from the following description, taken in connection with the accompanying examples, wherein by way of illustration and example, several embodiments of the present invention are disclosed.

### SUMMARY OF THE INVENTION

The term “2D materials” refers to monoatomic two-dimensional (2D) structures in the forms of sheets that are shown to have outstanding properties, including physical, chemical, electrical, optical, magnetic, thermal and mechanical.

The term “layered nanolaminates” refers to three dimensional structures where 2D sheets are assembled in horizontal layers.

The term “2D materials” refers to monoatomic two-dimensional (2D) structures in the forms of sheets.

The term “MXene” refers to a class of 2D inorganic compounds costing of a small number of atom think layers of transitional metal, carbides, nitrides or carbonotrides.

According to a first embodiment of the present invention, there is provided an X-ray radiation shielding material having a layered nanolaminate structure composed of assembled sheets of lead-free 2-dimensional (2D) materials with single or few atomic layers thickness and atomic number.

In preference, the layered nanolaminate composite structure has a thickness from 1.0 um to from 10.000 um

In preference, the 2D materials are at least one material selected from the group consisting of made of Transition Metal Dichalcogenides (Ti, V, Zr, Nb, Mo, Hf, Ta, W, Re, Pd. Pt), Group III and IV Chalcogenides (Al, Si, Ga, Ge, In, Sn, Sb, Bi) or Chalcogenides (S, Se, Te).

In preference, the layered nanolaminate structure is made by one type of 2D material, i.e. a homologous structure.

In preference, the layered nanolaminate structure is a composite made by two or more 2D materials., i.e. a heterologous structure.

In preference, the layered nanolaminate composite structure is made by two 2D materials in an alternating layer arrangement.

In preference, wherein the layered nanolaminate composite structure is made by two 2D materials mixed together.

In preference, the layered nanolaminate composite heterologous structure is made by at least two 2D materials and organized in an alternating layer arrangement.

In preference, the layered nanolaminate composite heterostructure is made by more than two 2D materials mixed together.

In preference, the X-ray radiation shielding material is combined with at least one of a metal film, polymer, clay or inorganic oxides, which are incorporated as one or more layers.

In preference, the X-ray radiation shielding material composite structure is made by two 2D materials organized into micro laminated segments of each 2D material composed of layered nanolaminate structures.

In preference, the micro laminated structures are organized in subsequent order of each 2D material

In preference, the micro laminated structures are organized in a random and mixed order of each 2D material

In preference, the composite heterostructures is made by more than two 2D materials organized into micro laminated segments of each 2D material composed of layered nanolaminate structures.

In preference, the micro laminated composite heterostructures is organized in subsequent order of each 2D material.

In preference, the micro laminated composite heterostructures are organized in random or mixed order of each 2D material.

In preference, the X-ray radiation shielding material is in combination with at least one other materials such selected from the group of metal films (Tin, Cu, Al, steel, Ni), polymer, clays and inorganic oxides, which are incorporated as one or more layers in their structure.

In preference, the X-ray radiation shielding material is in combination with incorporated leaded shielding materials such as leaded glass, leaded films, and/or Barium sulphate plasters etc.

In preference, the ionizing (X-ray, gamma, neutron) radiation shielding material includes layered nanolaminate structures (nacre like) composed of assembled sheets of lead-free 2-dimensional (2D) materials with single or few atomic layers thickness and atomic number

In preference, the X-ray radiation shielding material for Neutron radiation shielding nanolaminate structure of 2D materials including graphene, hexagonal boron nitride and boron-carbide

In preference, the X-ray radiation shielding material has layered nanolaminate composite structure has a thickness from 1.0 um to 10.000 um.

In preference, the X-ray radiation shielding material has layered nanolaminate composite structure is made of graphene and its derivates such graphene oxide, functionalized graphene and doped graphene.

In preference, the X-ray radiation shielding material has a layered nanolaminate composite structure is made of boron-doped graphene.

In preference, the X-ray radiation shielding material with layered nanolaminate composite structure is made of hexagonal boron nitride (hBN).

In preference, the X-ray radiation shielding material where the layered nanolaminate composite structure is made of boron carbide (BC).

In preference, the X-ray radiation shielding material where the layered nanolaminate composite structure is made of a combination of graphene or B-doped graphene and hBN.

In preference, the X-ray radiation shielding material where the layered nanolaminate composite structure is made of a combination of graphene or B doped graphene and boron carbide (BC).

In preference, the X-ray radiation shielding material, wherein layered the nanolaminate composite structure is made of a combination of hBN and boron carbide (BC).

In preference, the X-ray radiation shielding material where the layered nanolaminate composite heterostructure is made of a combination of graphene or B-doped graphene, hBN and boron carbide (BC) with equal ratio.

In preference, the X-ray radiation shielding material where the layered nanolaminate composite heterostructure is made of a combination of graphene or B-doped graphene, hBN and boron carbide (BC) with different ratio.

In preference, the X-ray radiation shielding material is combined with polymers such as HDPE, polyesters, epoxy etc.

In preference, the X-ray radiation shielding material is combined with other conventional neutron shielding materials.

In the context of the present invention, the expression “graphene-based” composite is intended to mean the composite has a composition comprising graphene, graphene oxide, partially reduced graphene oxide, reduced graphene oxide or a combination of two or more thereof. The expression “graphene-based” material may therefore be used herein as a convenient reference to graphene (material or sheets), graphene oxide (material or sheets), partially reduced graphene oxide (material or sheets), reduced graphene oxide (material or sheets) or a combination of two or more thereof.

### BRIEF DESCRIPTION OF THE DRAWINGS

By way of example only, an embodiment of the invention is described more fully hereafter, with reference to the accompanying drawings, in which:

FIG. 1 is a schematic representation of an embodiment of the present invention showing the 2D arrangement of material;

FIG. 2 is a graph showing the increase in attenuation of X-ray energy with reducing the thickness of material;

FIG. 3 is a graph showing the Raman spectra of bulk and exfoliated MoS₂;

FIG. 4 is a graph of average MoS₂ particle size distribution (ca 432 nm);

FIG. 5 is a TEM image of exfoliated MoS₂ (scale bar=10 nm), and inset picture a zoom-in image of six atomic layers of MoS₂ structure;

FIGS. 6a and 6a′ is a photograph and SEM image of bulk MoS₂ film;

FIGS. 7a and 7a′ is a photograph and SEM image of layered nanolaminated MoS₂ film

FIG. 8a is a graph of the X-ray transmission of bulk and exfoliated MoS₂ composite films, and the controls (air and membrane) (experimental data is extremely reproducible with a standard deviation±0.001%);

FIG. 8b is an-ray transmission of the exfoliated MoS₂ composite compared with increasing total composite film thicknesses;

FIG. 9 is an image of MXene film, SEM and TEM images as well as an Energy-dispersive spectrum (EDS) of the graph of the MXene film;

FIG. 10 is a graph showing X-ray transmission (%) of Mxene film A, B, C and D at different thicknesses (40-180 μm) performed using 30 KV X-ray energy using thickness 500 um and 1000 um showing shielding attenuation below 10%;

FIG. 11 is a schematic representation of the synthesis and film preparation, a) mechanical exfoliation of bulk antimony (Sb) combining wet-ball milling and ultrasonication in isopropanol/water (4:1) medium, b) conventional composite structure of X-ray shielding, c) sandwiched laminated approach of shielding;

FIG. 12 shows the structural and chemical properties of exfoliated FL-Sb. a) SEM micrograph of FL-Sb, b) particle size distribution (Inset image-dispersed FL-Sb in Isopropanol), c) high-resolution TEM image of FL-Sb, d) AFM of FL-Sb, e) line profile showing thickness of the FL-Sb, f) EDS spectrum of FL-Sb, g) X-ray diffraction pattern of FL-Sb, h) Raman spectrum of FL-Sb, i) TGA of FL-Sb;

### DETAILED DESCRIPTION OF THE INVENTION

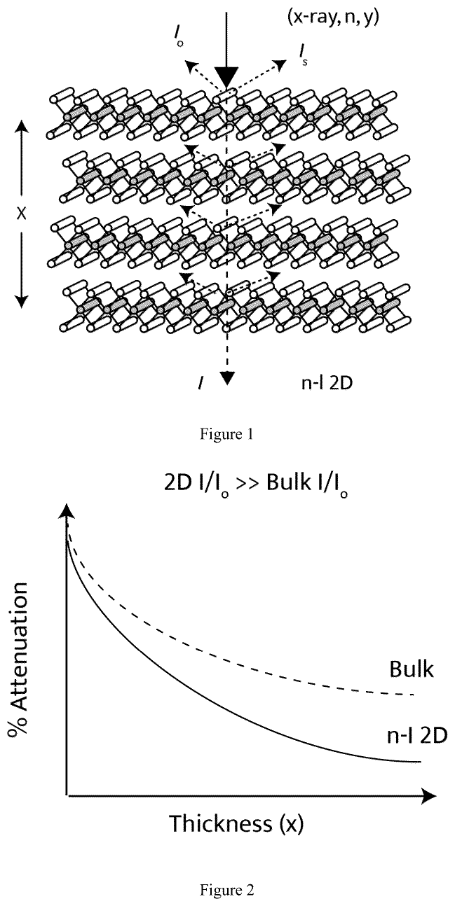

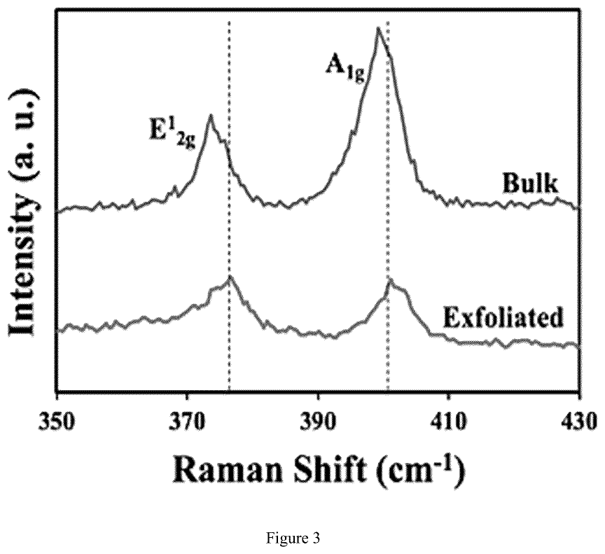

The present invention is based on the discovery that 2D materials with single or few atomic layer structures organized with nano-layered architecture with nanogaps can provide a structural modes of the radiation attenuation with additional scattering or absorption of photons, electrons and neutrons. This finding has not previously been observed and has not occurred in bulk structures where shielding is defined by Z number, density and materials thickness. The invention is to build on the synergetic combinations of structural properties of single atomic 2D sheets of 2D materials, their high surface area to the volume aspect ratio, and their nano-layered organization of the films with radiation absorption directed by z number that will provide a cascade of scattering/absorption events in interaction with electromagnetic waves, which is not possible with continuous bulk materials. An embodiment of the present invention is shown schematically in FIG. 1 with the scattering of X-ray over a series of 4 separate layers in the 2D arrangement. FIG. 2 shows the change in attenuation over a change in thickness of the material.

### Materials and methods

### Materials

Molybdenum disulphide powder (MoS₂, 99.99%, 23 μm) and sodium bromide (NaBr) was purchased from Chem-Supply (Australia). Carboxymethylcellulose sodium salt (CMC, high viscosity) was provided by Aldrich Sigma (Australia). Hydrophilic PTFE membrane filter (pore size: 0.45 μm, diameter: 47 mm, thickness: 25 μm) was purchased from Filter-Bio (China).

### Experiments

### Exfoliation of MoS₂ via Ball Milling

Bulk MoS₂ powder was exfoliated using a Planetary Ball Mill PM 200 (Retsch, Australia) with zirconium balls (3 mm in diameter). NaBr was added to facilitate the process of the ball milling with a weight ratio of NaBr: MoS₂ at 20:1, and the weight ratio of balls to powder was also 20:1. After the dry ball milling process, NaBr in the as-prepared mixture was washed several times with distilled (DI) water with the aid of a centrifuge (Sigma, Australia, 4200 rpm) and then dried in an oven at 50° C. overnight.

### MoS₂ Composite Films Preparation

Bulk and ball-milled (exfoliated) MoS₂ were dispersed with deionised (DI) water and then bath-sonicated for 1 h, respectively. CMC solution (0.5 wt. %) was added to the as-prepared MoS₂ solution with the optimized weight ratio. The mixture was then stirred constantly for 3 h and followed by vacuum filtration onto the membrane, and the composite film was then dried for 12 h in air at the ambient environment (24° C.).

### Characterization on MoS₂ Composite Films

The synthesized MoS₂ composite films were characterized by a scanning electron microscopy (SEM, FEI Quanta 450, USA) for surface morphology, and composite thickness. SEM was also performed in backscattered electron (BSE) mode to evaluate the homogeneity of the composite material at an accelerating voltage of 10 kV. X-ray diffractometer (XRD, Rigaku Miniflex 600, Japan) for the measurements of the crystalline forms in the composites were collected in the range of 2θ=20-80° (scan rate of 10° C. min⁻¹). The vibrational characterization and layer identification of bulk and exfoliated MoS₂ were analyzed by Raman spectroscopy (LabRAM HR Evolution, Horiba Jvon Yvon Technology, Japan) using 532 nm laser as the excitation source in the range of 300-500 cm⁻¹. A 50× objective was used with the laser powder kept at 100%, and all spectra were collected using an acquisition time of 1 s for 3 accumulations. The total composite film thickness (t_{CompM}) was calculated as equation (1),

$${t}_{CompM} = {t}_{Comp} + {t}_{M} \qquad ( 1 )$$

Where t_{Comp} is the composite thickness and t_{M} is the membrane thickness given as 25 μm.

### X-Ray Attenuation Testing

X-ray attenuation is the reduction of the intensity of X-ray when it travels through matter (Viegas et al., 2017). The attenuation properties of the controls (air and membrane) and as-prepared MoS₂ composite samples were measured using a Gulmay D3150 superficial X-ray (SXR) unit. The distances between the X-ray tube and the material sample, and the material sample to the detector were both set to 50 cm. The detector used to measure the transmission was a NE 2571 farmer type ionization chamber (Phoenix Dosimetry Ltd, UK). The samples were exposed to the X-ray voltage at 30 kVp (0.20 mm A1 HVL) for 0.50 mins with the material sample placed over a collimator of diameter 1 cm. The X-ray transmission was calculated as the charge collected by the ionization chamber with the sample divided by the transmission dose without the sample. Each sample was measured three times and determined by the arithmetic mean.

The X-ray attenuation of an X-ray beam through any material can be estimated as a function of the linear attenuation coefficient (μ) as equation (2),

$$I = {I}_{0} {e}^{- u t} \qquad ( 2 )$$

Where I and I₀ are the final X-ray intensity after the attenuation by the sample and the X-ray intensity before passing through the sample, respectively, and t is the material thickness (mm). The X-ray transmission (T) can be expressed as equation (3),

$$T = ( I / {I}_{0} ) \times 100 \% \qquad ( 3 )$$

### Characterization of Exfoliated MoS₂ and MoS₂ Composite Films

Facile and effective ball-milling methods exfoliate a large quantity of MoS₂ into small layered sheets in FIG. 2(a). SEM image in FIG. 2(b) showed that the large layered MoS₂ sheets with a particle size of 23 μm were exfoliated into the small and irregular sheets (FIG. 2(c)). EDX analysis was performed to evaluate whether additional elements were generated during ball-milling procedure. The elemental composition of both bulk and exfoliated MoS₂ indicated only the presence of Mo and S as major elements, there was no other additional alteration occurred after ball milling.

XRD is used to provide the evidence of phase identification for crystalline materials. A typical peak for MoS₂ at 2θ=14.9° and a decrease in intensity with an increase in width of the peak represented successfully exfoliated MoS₂ via ball milling. FTIR spectra indicated that a characteristic peak at 470 cm⁻¹ was detected in both bulk and exfoliated MoS₂, a decreasing intensity of this peak in the exfoliated MoS₂ could be contributed to the smaller thickness after ball milling.

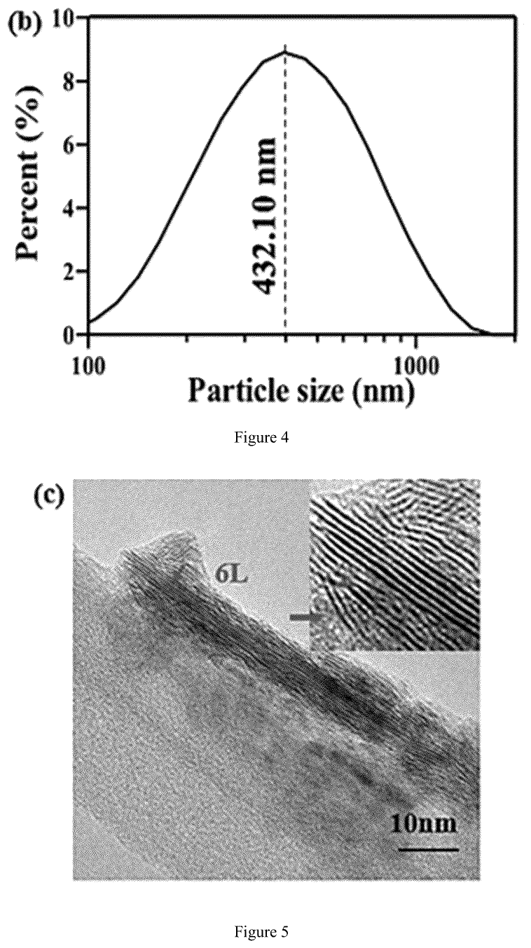

Raman spectrum of bulk and exfoliated MoS₂ are shown in FIG. 3, indicating that bulk MoS₃ was successfully converted to exfoliated MoS₂, where the typical A_{1g} and E¹_{2g} peaks of exfoliated MoS₂ were significantly weakened and blue-shifted by 2.45 cm⁻¹ relative to those of bulk MoS₂, due to the thickness and lateral size reduction. The frequency difference (Δω) between A_{1g} (401.20 cm⁻¹) and E¹_{2g} (376.60 cm⁻¹) of exfoliation MoS₂ was 24.60 cm⁻¹, which was applied to the identification of the layer number (N) as shown in equation (4),

$$Δ ω ( {A}_{1 g} - {E}_{2 g}^{1} ) = 25.8 - 8.4 / N \qquad ( 4 )$$

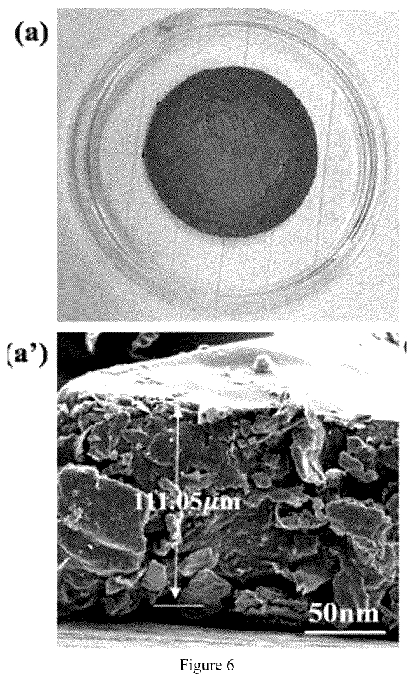

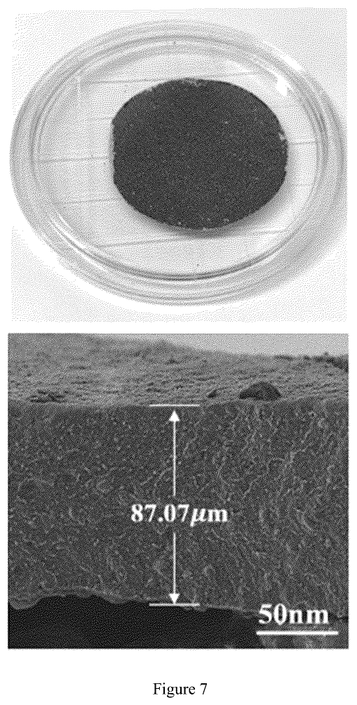

The calculated N of exfoliated MoS₂ was reduced to 7 layers, evidence of the successful delamination of the bulk MoS₂, which was supported by the particle size reduced to 432.10 nm in FIG. 4 and confirmed by TEM image in FIG. 5 as 6 layers

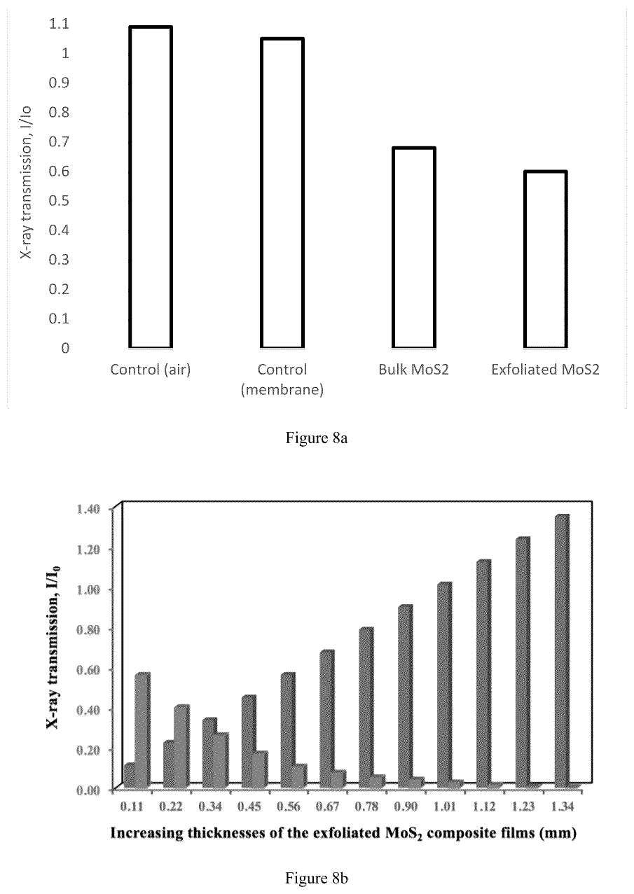

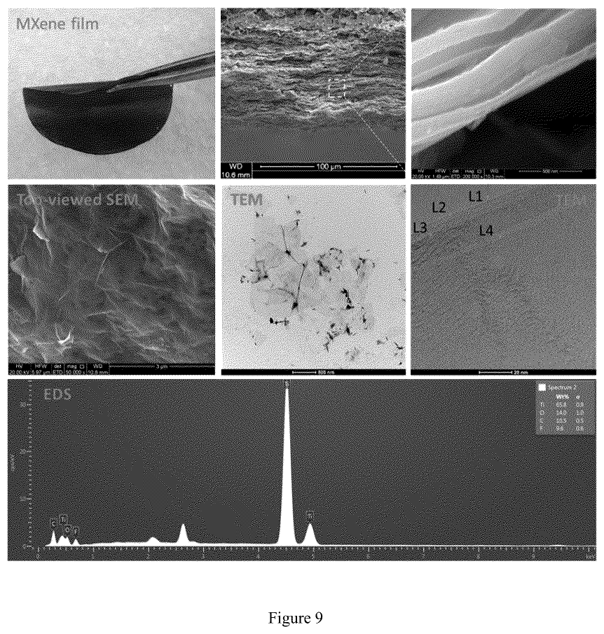

FIGS. 6a and 7a show the photographs of bulk and exfoliated MoS₂ composite films along with their SEM images (FIGS. 6b and 7b) of corresponding to their thicknesses. The thickness of bulk MoS₂ composite film was 111.05 μm, by adding the same amount of exfoliated MoS₂, the thickness of the composite film decreased to 87.07 μm in FIG. 5(a′, b′), it was due to the fact that the micro-sized MoS₂ sheets could not provide a dense and smooth coverage and also increase the voltage of the film.

### X-Ray Attenuation Measurements

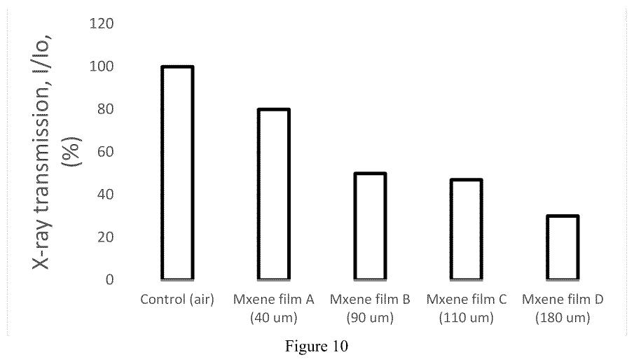

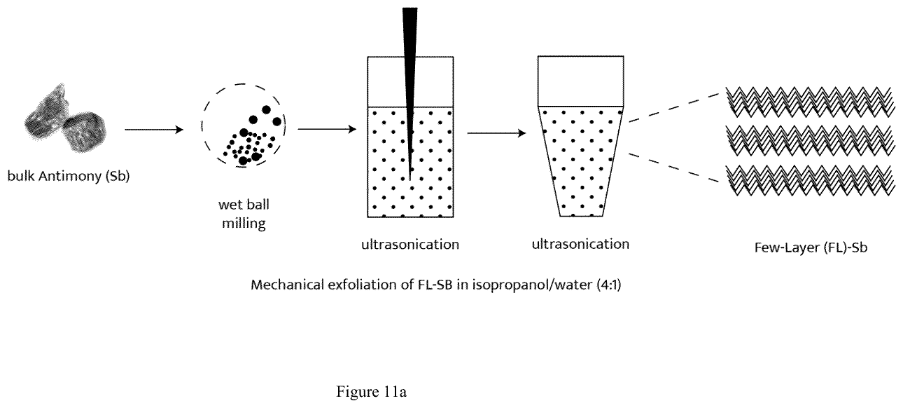

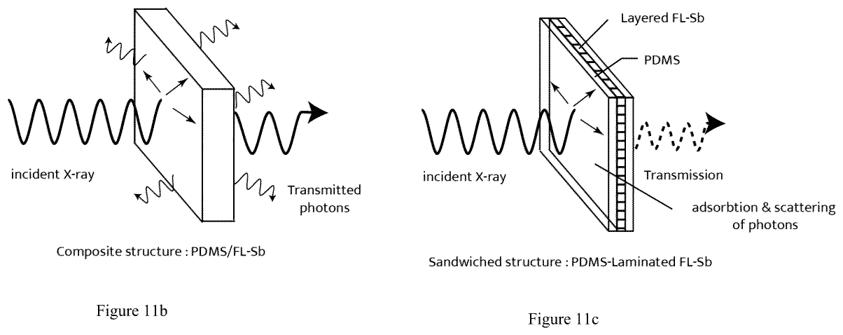

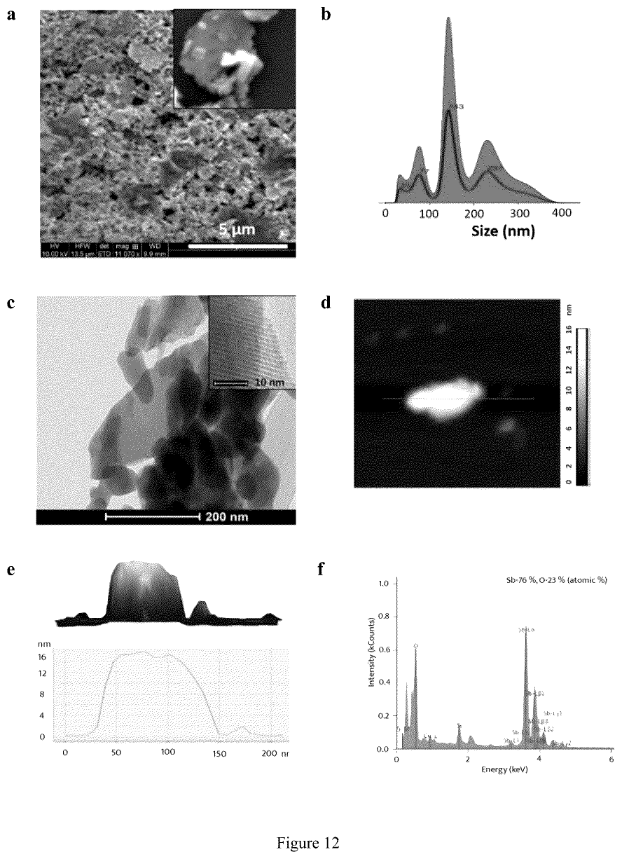

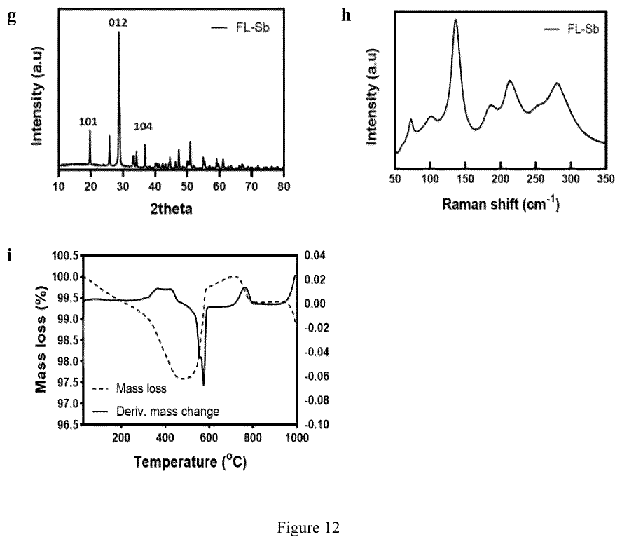

FIG. 8a shows the X-ray attenuation performance of the as-prepared MoS₂ composites compared to the controls (air and membrane). The membrane did show a slight decrease in the X-ray transmission but only by 1.20%; while it is negligible, there still is a small effect on the X-ray shielding. Comparing with bulk and exfoliated MoS₂ composites, it clearly illustrated that by decreasing the particle size of MoS₂ from 23 μm to 432.10 nm, there was a significant decrease on X-ray transmission from bulk MoS₂ composite (64.10%) to the exfoliated one (55.96%), indicating that exfoliated MoS₂ composite film presented more effective X-ray shielding ability with a less thickness (87.07 μm) compared to its bulk material.

### Material Thickness

The photon intensity of X-ray can be reduced by absorption or scattering by several factors, and thickness is one of important factors in radiation shielding application. FIG. 8b shows that by increasing the thickness of the exfoliated MoS₂ composite films from 0.11 mm to 1.34 mm this could attenuate X-ray transmission down to 0.09%, which was similar to X-ray transmission of 0.20 mm Pb (0.10%) calculated by XCOM. Although the optimized thickness (1.34 mm) was thicker than the 0.20 mm Pb-equivalent materials used for X-ray protection garments, the weight of optimized exfoliated MoS₂ composite films (minus the membranes) at 1.18 g was half lighter than the 0.20 mm Pb (2.17 g).

### MXene Preparation

The synthesis steps of MXene materials mainly followed a literature guideline [13]. Briefly, the small pieces of Ti₃AlC₂ max phase were ground into fine powders using a mortar, and the powders having a particle size of less than 25 μm were selected by a 25 μm sieve and collected for further use. Lithium fluoride (1.5 g) was added to 20 ml of 9M HCl solution in a reaction vessel under and stirred with a magnetic bar, then 1 gram of Ti₃AlC₂ was slowly added into the solution. The mixture was maintained in an oil bath environment at 35° C. for 24 h. After the etching reaction was completed, the reacted mixture was subjected to centrifugal washing with deionised H₂O at 3,500 rpm for 30 minutes. This washing procedure was repeated 5 to 6 times until the pH value reached around 6, and a relatively pure Ti₃C₂Tₓ product (MXene) was obtained.

After washing, the product was ultrasonically separated to obtain a two-dimensional layered MXene material. A small amount of MXene powder was obtained by drying the raw MXene material, and its electrical conductivity was tested. The resulting product was subjected to characterisation measurements (SEM, XRD and EDS) to observe its structure and predict its properties. This prepared MXene material was stored in the refrigerator and used in the subsequent preparation of conductive films.

### Fabrication of MXene Conductive Films

An appropriate amount of MXene material that was refrigerated was taken out, deionised water was added and sonicated for 1 hour to obtain an MXene suspension. The MXene suspension after sonication was allowed to stand for 2 hours, and the supernatant was taken for further use. Different volumes (2 ml, 5 mL and 8 mL) of as-prepared MXene solutions were slowly filtrated by a vacuum filtration system to form conductive films on the membranes. The MXene-deposited membrane connected to the suction filter was placed in a vacuum drying oven and dried at 40° C. for 12 h. After that, the entire system was taken out from the vacuum drying oven, the suction filter was removed, and then the dried MXene conductive film was carefully separated from the membrane. Resistance measurements on samples of different thicknesses were performed on a 4-point multi-height probe system, and the thickness of the films was measured by cross-sectional SEM images.

As shown above, the use of an embodiment of the present invention in exfoliated MoS₂ composite was applied to X-ray shielding applications. The optimized weight ratio of exfoliated MoS₂ composite with a thickness of 1.34 mm provided effective X-ray shielding performance at the low energy (30 kVp). In addition, the embodiment of the present invention shows that the weight of the exfoliated MoS₂ composite (1.18 g) provided the similar X-ray transmission as 0.20 mm Pb (2.17 g), and both of MoS₂ and CMC are economical and environmentally friendly raw materials, which further enhances the potential use of this novel composite shielding material. This new, lightweight, non-Pb material composite effectively demonstrates its ability as an X-ray shielding alternative to the traditional materials.
A. In some embodiments there is an X-ray radiation shielding material having a layered nanolaminate structure (nacre like) composed of assembled sheets of lead-free 2-dimensional (2D) materials with single or few atomic layers thickness and atomic number.
B. The radiation shielding material of A, wherein the layered nanolaminate composite structure has a thickness from 1.0 um to 10.000 um
C. The X-ray radiation shielding material of claim A or B, wherein the 2D materials are at least one material selected from the group consisting of made of Transition Metal Dichalcogenides (Ti, V, Zr, Nb, Mo, Hf, Ta, W, Re, Pd. Pt), Group III and IV Chalcogenides (Al, Si, Ga, Ge, In, Sn, Sb, Bi) or Chalcogenides (S, Se, Te).
D. The X-ray radiation shielding material of A or B, wherein the layered nanolaminate structure is made by one type of 2D material, i.e. a homologous structure.
E. The X-ray radiation shielding material of A or B, wherein the layered nanolaminate structure is a composite made by two or more 2D materials., i.e. a heterologous structure.
F. The X-ray radiation shielding material of E, wherein the layered nanolaminate composite structure is made by two 2D materials in an alternating layer arrangement.
G. The X-ray radiation shielding material of E, wherein the layered nanolaminate composite structure is made by two 2D materials mixed together.
H. The X-ray radiation shielding material of E, wherein the layered nanolaminate composite heterologous structure is made by at least two 2D materials and organized in an alternating layer arrangement.
I. The X-ray radiation shielding material of E, wherein the layered nanolaminate composite heterostructure is made by more than two 2D materials mixed together
J. The X-ray radiation shielding material of any one of E-H, combined with at least one of a metal film, polymer, clay or inorganic oxides which are incorporated as one or more layers.
K. The X-ray radiation shielding material of claim E, wherein the composite structure is made by two 2D materials organized into micro laminated segments of each 2D material composed of layered nanolaminate structures.
L. The X-ray radiation shielding material of claim K wherein the micro laminated structures are organized in the subsequent order of each 2D material
M. The X-ray radiation shielding material of claim K wherein the micro laminated structures are organized in a random and mixed order of each 2D material
N. The X-ray radiation shielding material of claim E, wherein the composite heterostructures is made by more than two 2D materials organized into micro laminated segments of each 2D material composed of layered nanolaminate structures.
O. The X-ray radiation shielding material of claim N wherein the micro laminated composite heterostructures is organized in the subsequent order of each 2D material.
P. The X-ray radiation shielding material of claim N wherein the micro laminated composite heterostructures are organized in a random or mixed order of each 2D material.
Q. The X-ray radiation shielding material of any one of K-P, in combination with at least one other materials such selected from the group of metal films (Tin, Cu, Al, steel, Ni), polymer, clays and inorganic oxides which are incorporated as one or more layers in their structure
R. The X-ray radiation shielding material of any one of A-Q in combination with incorporated leaded shielding materials such as leaded glass, leaded films, and/or Barium sulphate plasters etc.
S. Ionizing (X-ray, gamma, neutron) radiation shielding material comprising layered nanolaminate structures (nacre like) composed of assembled sheets of lead-free 2-dimensional (2D) materials with single or few atomic layers thickness and atomic number
T. The X-ray radiation shielding material of S for Neutron radiation shielding nanolaminate structure of 2D materials including graphene, hexagonal boron nitride (hBN) and boron-carbide (BN).
U. The X-ray radiation shielding material of T, wherein the layered nanolaminate composite structure has a thickness from 1.0 um to 10.000 um
V. The X-ray radiation shielding material of T and U, wherein the layered nanolaminate composite structure is made of graphene and its derivates such Graphene oxide, functionalized graphene and doped graphene
W. The X-ray radiation shielding material of T and U, wherein the layered nanolaminate composite structure is made of boron-doped graphene
X. The X-ray radiation shielding material of T and U, wherein the layered nanolaminate composite structure is made of hexagonal boron nitride (hBN)
Y. The X-ray radiation shielding material of T and U, wherein the layered nanolaminate composite structure is made of boron carbide (BC)
Z. The X-ray radiation shielding material of T and U where layered nanolaminate composite structure is made of a combination of graphene or B-doped graphene and hBN.
AA. The X-ray radiation shielding material of T and U, wherein the layered nanolaminate composite structure is made of a combination of graphene or B doped graphene and boron carbide (BC)
AB. The X-ray radiation shielding material of T and U, wherein layered nanolaminate composite structure is made of a combination of hBN and boron carbide (BC)
AC. The X-ray radiation shielding material of T and U where layered nanolaminate composite heterostructure is made of a combination of graphene or B-doped graphene, hBN and boron carbide (BC) with equal ratio.
AD. The X-ray radiation shielding material of T and U, wherein the layered nanolaminate composite heterostructure is made of a combination of graphene or B-doped graphene, hBN and boron carbide (BC) with different ratios.
AE. The X-ray radiation shielding material of T and AD combined with polymers such as HDPE, polyesters, epoxy etc
AF. The X-ray radiation shielding material of T and AD combined with other conventional neutron shielding materials

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. An X-ray radiation shielding material having a layered nanolaminate structure (nacre like) composed of assembled sheets of lead-free 2-dimensional (2D) materials with single or few atomic layers thickness and atomic number.

2. The X-ray radiation shielding material of claim 1, wherein the layered nanolaminate composite structure has a thickness from 1.0 um to 10.000 um

3. The X-ray radiation shielding material of claim 1, wherein the 2D materials are at least one material selected from the group consisting of made of Transition Metal Dichalcogenides (Ti, V, Zr, Nb, Mo, Hf, Ta, W, Re, Pd. Pt), Group III and IV Chalcogenides (Al, Si, Ga, Ge, In, Sn, Sb, Bi) or Chalcogenides (S, Se, Te).

4. The X-ray radiation shielding material of claim 1, wherein the layered nanolaminate structure is made by one type of 2D material, i.e. a homologous structure.

5. The X-ray radiation shielding material of claim 1, wherein the layered nanolaminate structure is a composite made by two or more 2D materials., i.e. a heterologous structure.

6. The X-ray radiation shielding material of claim 5, wherein the layered nanolaminate composite structure is made by two 2D materials in an alternating layer arrangement.

7. The X-ray radiation shielding material of claim 5, wherein the layered nanolaminate composite structure is made by two 2D materials mixed together.

8. The X-ray radiation shielding material of claim 5, wherein the layered nanolaminate composite heterologous structure is made by at least two 2D materials and organized in an alternating layer arrangement.

9. The X-ray radiation shielding material of claim 5, wherein the layered nanolaminate composite heterostructure is made by more than two 2D materials mixed together

10. The X-ray radiation shielding material of claim 5, combined with at least one of a metal film, polymer, clay or inorganic oxides which are incorporated as one or more layers.

11. The X-ray radiation shielding material of claim 5, wherein the composite structure is made by two 2D materials organized into micro laminated segments of each 2D material composed of layered nanolaminate structures.

12. The X-ray radiation shielding material of claim 11, wherein the micro laminated structures are organized in the subsequent order of each 2D material

13. The X-ray radiation shielding material of claim 11, wherein the micro laminated structures are organized in a random and mixed order of each 2D material

14. The X-ray radiation shielding material of claim 5, wherein the composite heterostructures is made by more than two 2D materials organized into micro laminated segments of each 2D material composed of layered nanolaminate structures.

15. The X-ray radiation shielding material of claim 14, wherein the micro laminated composite heterostructures is organized in the subsequent order of each 2D material.

16. The X-ray radiation shielding material of claim 14, wherein the micro laminated composite heterostructures are organized in a random or mixed order of each 2D material.

17. The X-ray radiation shielding material of claim 11, in combination with at least one other materials such selected from the group of metal films (Tin, Cu, Al, steel, Ni), polymer, clays and inorganic oxides which are incorporated as one or more layers in their structure

18. The X-ray radiation shielding material of claim 1, in combination with incorporated leaded shielding materials such as leaded glass, leaded films, and/or Barium sulphate plasters etc.

19. An ionizing (X-ray, gamma, neutron) radiation shielding material comprising layered nanolaminate structures (nacre like) composed of assembled sheets of lead-free 2-dimensional (2D) materials with single or few atomic layers thickness and atomic number

20. The X-ray radiation shielding material of claim 19, for Neutron radiation shielding nanolaminate structure of 2D materials including graphene, hexagonal boron nitride (hBN) and boron-carbide (BN).

21. The X-ray radiation shielding material of claim 20, wherein the layered nanolaminate composite structure has a thickness from 1.0 um to 10.000 um

22. The X-ray radiation shielding material of claim 20, wherein the layered nanolaminate composite structure is made of graphene and its derivates such Graphene oxide, functionalized graphene and doped graphene

23. The X-ray radiation shielding material of claim 20, wherein the layered nanolaminate composite structure is made of boron-doped graphene

24. The X-ray radiation shielding material of claim 20, wherein the layered nanolaminate composite structure is made of hexagonal boron nitride (hBN)

25. The X-ray radiation shielding material of claim 20, wherein the layered nanolaminate composite structure is made of boron carbide (BC)

26. The X-ray radiation shielding material of claim 20, where layered nanolaminate composite structure is made of a combination of graphene or B-doped graphene and hBN.

27. The X-ray radiation shielding material of claim 20, wherein the layered nanolaminate composite structure is made of a combination of graphene or B doped graphene and boron carbide (BC)

28. The X-ray radiation shielding material of claim 20, wherein layered nanolaminate composite structure is made of a combination of hBN and boron carbide (BC)

29. The X-ray radiation shielding material of claim 20, where layered nanolaminate composite heterostructure is made of a combination of graphene or B-doped graphene, hBN and boron carbide (BC) with equal ratio.

30. The X-ray radiation shielding material of claim 20, wherein the layered nanolaminate composite heterostructure is made of a combination of graphene or B-doped graphene, hBN and boron carbide (BC) with different ratios.

31. The X-ray radiation shielding material of claim 20 combined with polymers such as HDPE, polyesters, epoxy etc

32. The X-ray radiation shielding material of claim 20 combined with other conventional neutron shielding materials.
